(19) United States
(12) Patent Application Publication
(10) Pub. No.: US 2015/0279510 A1
(43) Pub. Date: Oct. 1, 2015

(54) Winding Wire and Composition for Wiring Wire

(71) Applicant: Hitachi Metals, Ltd., Tokyo (JP)

(72) Inventors: Hidehito Hanawa, Hitachi (JP); Shuta Nabeshima, Hitachi (JP)

(21) Appl. No.: 14/641,182

(22) Filed: Mar. 6, 2015

(30) Foreign Application Priority Data
Mar. 25, 2014 (JP) 2014-61628

(51) Int. Cl. H01B 3/30; H01B 7/02; H01B 7/00; H01B 1/02

(52) U.S. Cl. CPC H01B 3/305; H01B 1/02; H01B 7/0291; H01B 7/0054; H01B 3/306

(57) ABSTRACT

A winding wire includes a conductor and a partial-discharge-resistant coating layer on the conductor. The partial-discharge-resistant coating layer contains a base resin, electrically insulating fine inorganic particles present in the base resin, and fine conductive particles present in the base resin in an amount of 1.25 to 3.00 parts by weight based on 100 parts by weight of the base resin.

The present application is based on Japanese patent application No. 2014-61628 filed on Mar. 25, 2014, the entire contents of which are incorporated herein by reference.

### BACKGROUND OF THE INVENTION

1. Field of the Invention

The present invention relates to winding wires and coating compositions for winding wires.

2. Description of the Related Art

Enameled wires, which are conductors having an insulating coating (i.e., an enamel coating) thereon, are used as winding wires to form coils for devices such as motors and transformers.

Inverters are used as voltage controllers for efficient variable-speed motor control. Because inverters are controlled by high-speed switching devices that operate at several kilohertz to several hundreds of kilohertz, a high surge voltage occurs when a voltage is applied thereto. Recent inverters use high-speed switching devices such as insulated-gate bipolar transistors (IGBTs) to achieve a steep voltage rise, which induces an instantaneous surge voltage of up to twice the output voltage. This surge voltage causes partial discharge on the surface of a coil of enameled wire and erodes its enamel coating. The erosion of the enamel coating due to partial discharge eventually leads to dielectric breakdown.

One approach to reducing the influence of the surge voltage is to form a coating resistant to erosion due to partial discharge. For example, Japanese Unexamined Patent Application Publication Nos. 2000-331539 and 2004-204187 propose partial-discharge-resistant insulated electric wires (inverter-surge-resistant enameled wires). These electric wires have a coating containing fine inorganic particles, which reduce erosion due to discharge.

Another approach is to increase the partial discharge inception voltage (PDIV) to reduce partial discharge and thereby extend the charge life. This approach can be practiced, for example, by forming a thicker coating, or by reducing the dielectric constant, as disclosed in Japanese Unexamined Patent Application Publication Nos. 2010-132725 and 2010-189510. Although the former method, i.e., forming a thicker coating, increases the PDIV, it has problems such as decreased mechanical properties after winding and increased coil diameter.

### SUMMARY OF THE INVENTION

Recent motors are more prone to partial discharge than before because they operate at a higher voltage due to inverter control and specifications such as high-speed switching are common. As motors become smaller, coatings on enameled wires are exposed to a higher stress, for example, due to elongation, friction, or bending. In hybrid vehicles and electric vehicles, partial discharge can be more likely to occur due to environmental factors such as temperature, humidity, and a decrease in atmospheric pressure during high-altitude driving. Enameled wires are exposed to a higher load than before and are more susceptible to a decrease in insulation properties due to damage by partial discharge.

An object of the present invention is to provide a winding wire having a novel structure resistant to damage due to partial discharge and a coating composition for winding wires that can be used to form such a winding wire.

(1) According to one exemplary aspect of the invention, a winding wire include a conductor and a partial-discharge-resistant coating layer on the conductor, the partial-discharge-resistant coating layer including a base resin, electrically insulating fine inorganic particles present in the base resin, and fine conductive particles present in the base resin in an amount of 1.25 to 3.00 parts by weight based on 100 parts by weight of the base resin.

In the above exemplary invention (1), many exemplary modifications and changes can be made as below the following exemplary modifications and changes can be made.

(i) The winding wire is further including an insulating coating layer on the partial-discharge-resistant coating layer.

(ii) The fine conductive particles have an average particle size of 100 nm or less.

(2) According to another aspect of the present invention, a coating composition for a winding wire, including a base resin coating composition comprising a base resin, electrically insulating fine inorganic particles present in the base resin coating composition, and fine conductive particles present in the base resin coating composition in an amount of 1.25 to 3.00 parts by weight based on 100 parts by weight of the base resin.

### <Points of the Invention>

The base resin (base resin coating composition) containing both of the electrically insulating fine inorganic particles and the fine conductive particles allow the resulting winding wire to have a longer charge life than a base resin (base resin coating composition) containing only the fine inorganic particles.

### BRIEF DESCRIPTION OF THE DRAWINGS

The foregoing and other exemplary purposes, aspects and advantages will be better understood from the following detailed description of the invention with reference to the drawings, in which:

FIG. 1A is a schematic sectional view of a winding wire according to an embodiment of the present invention, and FIG. 1B is a table showing the results of characteristics tests on the winding wires of the Examples and the Comparative Examples.

### DESCRIPTION OF THE PREFERRED EMBODIMENTS

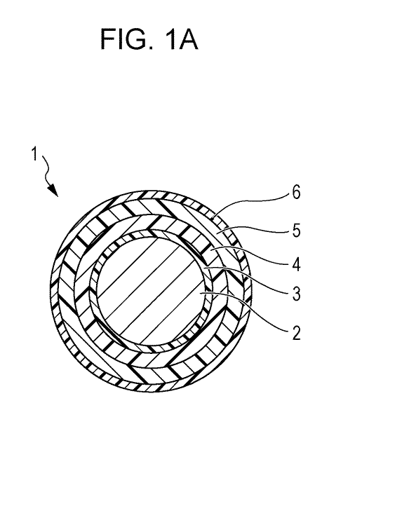

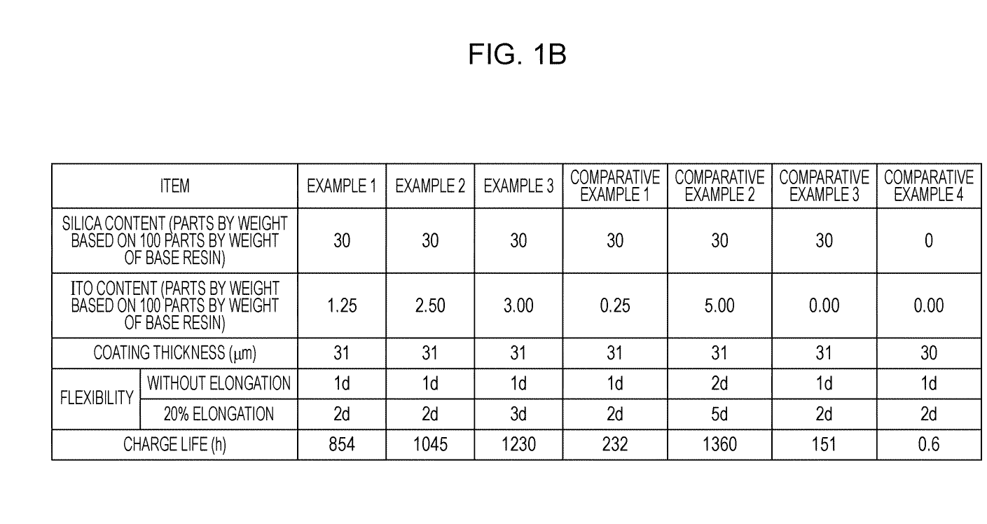

A winding wire according to an embodiment of the present invention will now be described with reference to FIG. 1A. FIG. 1A is a schematic sectional view of the winding wire according to this embodiment. A winding wire 1 according to this embodiment includes a conductor 2, an adhesion layer 3, a partial-discharge-resistant coating layer 4, an insulating coating layer 5, and a smooth coating layer 6.

The conductor 2 is, for example, a copper wire, an aluminum wire, a silver wire, a nickel wire, or a nickel-plated copper wire. The adhesion layer 3 may optionally be provided between the conductor 2 and the partial-discharge-resistant coating layer 4 to improve the adhesion between the conductor 2 and the partial-discharge-resistant coating layer 4. The adhesion layer 3 is based on, for example, a polyester-imide resin, a polyamide-imide resin, or a polyimide resin. The adhesion layer 3 is formed, for example, by applying an adhesive coating composition containing a polyester-imide resin, a polyamide-imide resin, or a polyimide resin and an adhesion improver to the conductor 2 and baking the resulting coating.

The partial-discharge-resistant coating layer 4 is disposed on the conductor 2 (if the adhesion layer 3 is provided, with the adhesion layer 3 therebetween). The partial-discharge-resistant coating layer 4 contains a base resin, fine inorganic particles, and fine conductive particles. The fine inorganic particles present in the partial-discharge-resistant coating layer 4 can reduce erosion due to partial discharge. Additionally, in this embodiment, the fine conductive particles present in the partial-discharge-resistant coating layer 4 can reduce the intensity of the electric field in the partial-discharge-resistant coating layer 4 to increase the partial discharge inception voltage (PDIV) and thereby to reduce partial discharge. Specific examples of advantages of the fine inorganic particles and the fine conductive particles present in the partial-discharge-resistant coating layer 4 will be described later in the Examples.

The partial-discharge-resistant coating layer 4 is formed, for example, as follows. The base resin may be, for example, a polyamide-imide resin, a polyimide resin, or a polyester-imide resin. The use of a polyamide-imide resin as the base resin will now be described by way of example. The polyamide-imide resin can be prepared, for example, by reacting mainly two components, i.e., an isocyanate component such as 4,4′-diphenylmethane diisocyanate (MDI) and an acid component such as trimellitic anhydride (TMA), in a solvent. Examples of solvents for use in the polyamide-imide resin coating composition include γ-butyrolactone, N-methyl-2-pyrrolidone (NMP), N,N-dimethylformamide (DMF), N,N-dimethylacetamide (DMAC), dimethylimidazolidinone (DMI), and cyclic ketones. These solvents can be used alone or in combination.

A partial-discharge-resistant coating composition according to this embodiment is prepared by adding the fine inorganic particles and the fine conductive particles to the polyamide-imide resin coating composition containing the polyamide-imide resin and the solvent. For simplicity of expression, the term “polyamide-imide resin coating composition” as used herein encompasses a coating composition containing a precursor of the polyamide-imide resin to be synthesized. This also applies to coating compositions containing base resins other than polyamide-imide resins.

The fine inorganic particles are added to the polyamide-imide resin coating composition by adding an organosol containing fine inorganic particles for reducing erosion due to partial discharge. The fine inorganic particles may be, for example, electrically insulating fine inorganic particles such as silica, aluminum, titanic, or zirconia. The dispersion medium for the organosol containing the fine inorganic particles may be, for example, a dispersion medium based on a cyclic ketone (main dispersion medium) having a boiling point of 130° C. to 180° C. Examples of such cyclic ketones include cycloheptanone (boiling point: 180° C.), cyclohexanone (boiling point: 156° C.), and cyclopentanone (boiling point: 131° C.). These cyclic ketones can be used alone or in combination. Fully or partially unsaturated cyclic ketones such as 2-cyclohexen-1-one can also be used.

To improve the partial discharge resistance, the fine inorganic particles preferably have an average particle size of 100 nm or less. For reasons of the transparency of the organosol itself and the flexibility of the winding wire, the fine inorganic particles more preferably have an average particle size of 30 nm or less.

The fine conductive particles are added to the polyamide-imide resin coating composition, for example, by adding an organosol containing fine conductive particles such as indium tin oxide (ITO), zinc oxide, tin oxide, or carbon nanotubes (CNTs). For example, ITO is preferred as the fine conductive particles for its availability. CNTs are also preferred for their characteristics, although they are more expensive than ITO. The dispersion medium for the organosol containing the fine inorganic particles may be, for example, xylene or a lower alcohol. The partial-discharge-resistant coating layer 4, which is formed using the fine conductive particles, preferably has an insulation resistance of 1.0×10⁶ Ω·cm or less. As with the fine inorganic particles, the fine conductive particles preferably have an average particle size of 100 nm or less, and for reasons of the flexibility of the winding wire, more preferably have an average particle size of 30 nm or less.

In this way, the fine inorganic particles and the fine conductive particles are added to the polyamide-imide resin coating composition containing the polyamide-imide resin and the solvent to prepare a partial-discharge-resistant coating composition. The partial-discharge-resistant coating composition is applied to the conductor 2 (if the adhesion layer 3 is provided, with the adhesion layer 3 therebetween) and is baked to form the partial-discharge-resistant coating layer 4.

The fine inorganic particles are preferably present in the partial-discharge-resistant coating layer 4 in an amount of 15 to 30 parts by weight based on 100 parts by weight of the base resin. Excess fine inorganic particles lose their dispersibility and coalesce (aggregate) together and thus significantly decrease the mechanical properties of the winding wire.

The fine conductive particles are preferably present in the partial-discharge-resistant coating layer 4 in an amount of 1.25 to 3.00 parts by weight based on 100 parts by weight of the base resin. The preferred amount of fine conductive particles will be discussed later in the Examples (see FIG. 1B).

The insulating coating layer 5 is disposed on the partial-discharge-resistant coating layer 4. The insulating coating layer 5 is made of, for example, a common polyamide-imide resin or a common polyimide resin. The insulating coating layer 5 is formed, for example, by applying a polyamide-imide resin coating composition or a polyimide resin coating composition to the partial-discharge-resistant coating layer 4 and baking the resulting coating.

The smooth coating layer 6 may optionally be provided on the insulating coating layer 5 as an outermost insulating layer for improved smoothness. The smooth coating layer 6 is based on, for example, a polyamide-imide resin. The smooth coating layer 6 is formed by applying a smooth polyamide-imide resin coating composition containing a polyamide-imide resin and a lubricant to the insulating coating layer 5 and baking the resulting coating. As described above, the winding wire 1 according to this embodiment is an enameled wire formed by repeatedly applying to the conductor 2 and baking enamel coating compositions.

### EXAMPLES

By way of example of the embodiment described above, the winding wires of the Examples will now be described in conjunction with the winding wires of the Comparative Examples. The winding wire of each example was fabricated as follows. A partial-discharge-resistant coating composition was prepared by adding silica to a polyamide-imide resin coating composition in an amount of 30 parts by weight based on 100 parts by weight of the polyamide-imide resin (base resin), stirring the mixture, and adding ITO to the mixture in an amount of 1.25 to 3.00 parts by weight based on 100 parts by weight of the base resin.

### Example 1

In Example 1, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin and fine ITO particles with an average particle size of 30 nm dispersed in xylene in an amount of 1.25 parts by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Example 1 was fabricated.

### Example 2

In Example 2, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin and fine ITO particles with an average particle size of 30 nm dispersed in xylene in an amount of 2.50 parts by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Example 2 was fabricated.

### Example 3

In Example 3, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin and fine ITO particles with an average particle size of 30 nm dispersed in xylene in an amount of 3.00 parts by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Example 3 was fabricated.

### Comparative Example 1

In Comparative Example 1, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin and fine ITO particles with an average particle size of 30 nm dispersed in xylene in an amount of 0.25 part by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Comparative Example 1 was fabricated.

### Comparative Example 2

In Comparative Example 2, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin and fine ITO particles with an average particle size of 30 nm dispersed in xylene in an amount of 5.00 parts by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Comparative Example 2 was fabricated.

### Comparative Example 3

In Comparative Example 3, a partial-discharge-resistant coating composition was prepared by adding, to a polyamide-imide resin coating composition serving as a base, fine silica particles with an average particle size of 30 nm dispersed in cyclohexanone in an amount of 30 parts by weight based on 100 parts by weight of the base resin. The partial-discharge-resistant coating composition was applied at a thickness of 25 μm to a copper wire with a conductor diameter of 0.80 mm and was baked to form a partial-discharge-resistant coating layer. A polyamide-imide resin coating composition was further applied at a thickness of 6 μm to the partial-discharge-resistant coating layer and was baked to form a high-toughness polyamide-imide resin layer serving as an insulating coating layer. In this way, the winding wire of Comparative Example 3 was fabricated.

### Comparative Example 4

In Comparative Example 4, a polyamide-imide resin coating composition was applied at a thickness of 30 μm to a copper wire with a conductor diameter of 0.80 mm and was baked to form a high-toughness polyamide-imide resin layer serving as an insulating coating layer. In this way, the winding wire of Comparative Example 4 was fabricated.

In summary, the winding wires of Examples 1 to 3 and Comparative Examples 1 and 2 had a partial-discharge-resistant coating layer containing a base resin, fine inorganic particles, and fine conductive particles. The winding wire of Comparative Example 3 had a partial-discharge-resistant coating layer containing a base resin and fine inorganic particles. The winding wire of Comparative Example 4 had no partial-discharge-resistant coating layer.

The winding wires (enameled wires) of the Examples and the Comparative Examples were tested and evaluated for their flexibility and charge life (V-t characteristics) under the following conditions. The table in FIG. 1B summarizes the results of the characteristics tests. For the enameled wires of Examples 1 to 3 and Comparative Examples 1 to 3, the total thickness of the partial-discharge-resistant coating layer and the insulating coating layer was 31 μm. For the enameled wire of Comparative Example 4, the thickness of the insulating coating layer alone was 30 μm.

### (1) Flexibility Test

In a flexibility test without elongation, an unelongated enameled wire was wound around a core having a diameter of 1 to 10 times the conductor diameter of the enameled wire by the method according to “JIS C 3003 7.1.1a Winding”, and the minimum winding ratio (d) at which no crack occurred in the insulating coating was measured under a light microscope. In a flexibility test after 20% elongation, an enameled wire was 20% elongated by the method according to “JIS C 3003 7.1.1a Winding” and was tested as in the flexibility test without elongation, and the minimum winding ratio (d) at which no crack occurred in the insulating coating was measured under a light microscope.

The results of the flexibility test without elongation will now be described. The minimum winding diameter at which no crack occurred (hereinafter simply referred to as “minimum winding diameter”) of the enameled wire of Comparative Example 4, which is a common enameled wire having no partial-discharge-resistant coating layer, was equal to its diameter (i.e., 1d). The minimum winding diameters of the enameled wires of Comparative Examples 1 and 3 and the enameled wires of Examples 1 to 3 were equal to their respective diameters (i.e., 1d), indicating that they had a similar flexibility to the common enameled wire of Comparative Example 4. The minimum winding diameter of the enameled wire of Comparative Example 2 was twice its diameter (i.e., 2d), indicating that it had rather low flexibility. This is probably because the fine conductive particles were present in a larger amount in Comparative Example 2 than in Comparative Example 1 and Examples 1 to 3.

The results of the flexibility test after 20% elongation will now be described. The minimum winding diameter of the common enameled wire of Comparative Example 4 was twice its diameter (i.e., 2d). The minimum winding diameters of the enameled wires of Comparative Examples 1 and 3 and the enameled wires of Examples 1 and 2 were twice their respective diameters (i.e., 2d), indicating that they had a similar flexibility to the common enameled wire of Comparative Example 4. The minimum winding diameter of the enameled wire of Example 3 was three times its diameter (i.e., 3d), indicating that it had a slightly lower but satisfactory flexibility. The minimum winding diameter of the enameled wire of Comparative Example 2 was five times its diameter (i.e., 5d), indicating that it had rather low flexibility, as in the flexibility test without elongation.

### (2) Charge Life (V-t Characteristics) Test

The results of the charge life (V-t characteristics) test will now be described. The V-t characteristics test evaluates the partial discharge resistance. The V-t characteristics test was carried out using a twisted pair cable at room temperature by applying a sinusoidal voltage of 1.0 kVrms at 10 kHz to measure the time to dielectric breakdown.

The enameled wires of Comparative Examples 1 to 3 and the enameled wires of Examples 1 to 3, which had a partial-discharge-resistant coating layer, had better V-t characteristics (i.e., a longer charge life) than the common enameled wire of Comparative Example 4. The enameled wires of Comparative Examples 1 and 2 and the enameled wires of Examples 1 to 3, which had a partial-discharge-resistant coating layer containing fine conductive particles, had better V-t characteristics than the enameled wire of Comparative Example 3, which had a partial-discharge-resistant coating layer containing no fine conductive particles. In particular, the times to dielectric breakdown of the enameled wires of Comparative Example 2 and Examples 1 to 3 were, for example, at least five times longer than that of Comparative Example 3.

### (3) Comprehensive Evaluation of Characteristics Tests

The comprehensive evaluation of the results of these characteristics tests is as follows. The enameled wires of Examples 1 to 3 had high flexibility and a long charge life (V-t characteristics). These results demonstrate that the fine conductive particles are preferably present in the partial-discharge-resistant coating layer in an amount of 1.25 to 3.00 parts by weight based on 100 parts by weight of the base resin.

Such enameled wires are suitable, for example, for use as wiring wires for electrical devices such as inverter motors and transformers in harsh environments where they are exposed to a high stress, for example, due to elongation, friction, or bending, or where partial discharge tends to occur due to high voltage or high-speed switching.

Although the present invention has been described with reference to the foregoing embodiment and examples, they are not intended to limit the present invention. For example, it would be obvious to one skilled in the art that various modifications, improvements, and combinations are possible. It should also be noted that not all combinations of features recited in the foregoing embodiment and examples are essential for achieving the object of the invention.

What is claimed is:

1. A winding wire comprising:
a conductor; and
a partial-discharge-resistant coating layer on the conductor, the partial-discharge-resistant coating layer comprising
a base resin,
electrically insulating fine inorganic particles present in the base resin, and
fine conductive particles present in the base resin in an amount of 1.25 to 3.00 parts by weight based on 100 parts by weight of the base resin.

2. The winding wire according to claim 1, further comprising an insulating coating layer on the partial-discharge-resistant coating layer.

3. The winding wire according to claim 1, wherein the fine conductive particles have an average particle size of 100 nm or less.

4. A coating composition for a winding wire, comprising:
a base resin coating composition comprising a base resin;
electrically insulating fine inorganic particles present in the base resin coating composition; and
fine conductive particles present in the base resin coating composition in an amount of 1.25 to 3.00 parts by weight based on 100 parts by weight of the base resin.
